(19) United States
(12) Patent Application Publication
(10) Pub. No.: US 2006/0212836 A1
(43) Pub. Date: Sep. 21, 2006

(54) Personalized user interfaces for presentation-oriented web services

(75) Inventors: Deepali Khushraj, Waltham, MA (US); Ora Lassila, Hollis, NH (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/376,401

(22) Filed: Mar. 15, 2006

Related U.S. Application Data
(60) Provisional application No. 60/662,071, filed on Mar. 15, 2005.

(51) Int. Cl. G06F 17/00

(52) U.S. Cl. 715/866

(57) ABSTRACT

A method of facilitating a service includes receiving a description of a service, and invoking the service based on the description. In this regard, the description comprises one having been generated based on an ontology including a set of classes, instances and associated properties for describing a user interface (UI) that includes one or more fields. The set of classes, instances and associated properties include a class for describing a field of the UI, and one or more properties for describing a name of the respective field and/or a UI widget for implementing the respective field. In this regard, the description includes a UI model of the service, where the UI model includes one or more of the classes, instances and associated properties of the ontology. Invoking the service, then, includes generating a UI based on the UI model.

### CROSS REFERENCE TO RELATED APPLICATION(S)

This application claims the benefit of U.S. Provisional Patent Application No. 60/662,071, entitled: Personalized User Interfaces for Presentation-Oriented Web Services, and filed Mar. 15, 2005, the content of which is incorporated herein in its entirety.

### FIELD OF THE INVENTION

The present invention generally relates to systems and methods of accessing Web services and, more particularly, relates to systems and methods of automatically and dynamically generating user interfaces for accessing Web services.

### BACKGROUND OF THE INVENTION

The World Wide Web has developed primarily as medium of content for human consumption. Automating tasks on the Web (such as information retrieval, synthesis of information, etc.) is difficult because human interpretation is often required to make information content useful. Offering relief, a new architecture for the Web is emerging, known as the “Semantic Web.” In broad terms, the Semantic Web encompasses efforts to create mechanisms that augment content with formal semantics, thereby producing content suitable for automated systems (e.g., intelligent software agents) to consume. The Semantic Web permits more automated functions on the Web (e.g., reasoning, information and service discovery, service composition, etc.), easing the workload of its users.

The Semantic Web will also pave the way for true “device independence” and customization of information content for individual users. Information on the Web can now exist in a “raw form” and any context-dependent presentation can be rendered on demand (more generally, the Semantic Web represents a departure from the current “rendering-oriented” Web). It is important to note that the Semantic Web is not a separate Web but an extension of the current one in which information, when given this well-defined meaning, better enables computers and people to work in tandem.

In the Semantic Web, content and services can be described using representation languages such as RDF (Resource Description Framework) and OWL (Ontology Web Language). In this regard, representations often refer to ontologies or specifications of conceptualizations that, in turn, enable reasoning via the use of logic rules. More particularly, ontologies may define domains by specifying, for example, concepts (i.e., classes), relationships between concepts, properties of concepts (i.e., slots), restrictions on properties (i.e., facets), individuals (i.e., instances), or the like. Ontologies may include, for example, personal information management (PIM) ontologies, location ontologies, temporal ontologies, friend-of-a-friend (FOAF) ontologies, composite capability/preference profiles (CC/PP) schema, Web service ontologies (e.g., OWL-S, Web Service Modeling Ontology—WSMO), policy ontologies, and the like. For more information on the Semantic Web, see Berners-Lee, Hendler, and Lassila, The Semantic Web, SCIENTIFIC AMERICAN, 284(5):3443, May 2001.

The application of Semantic Web technologies to Web services may be referred to as Semantic Web services whereby descriptions of service interfaces are associated with formal semantics, allowing software agents to describe their functionality, discover and “understand” other agents' functionality and invoke services provided by other agents. Furthermore, it may be possible to combine multiple services into new services. Work on Semantic Web services is at least partially driven by the possibility to automate things that formerly have required human involvement, consequently leading to improved interoperability.

OWL-S (formerly DAML-S) is one of the recently emerged ontologies for semantic annotation of Web service descriptions. The OWL-S ontology is written in the ontology language OWL. Web services annotated using OWL-S can be automatically discovered, composed into new services, invoked, and their execution automatically monitored. The process model of OWL-S can be used to specify how a service works by providing a semantic description of its inputs, outputs, preconditions, post conditions and process flow. The OWL-S description can be grounded to, among other standards, a WSDL (Web Service Definition Language) description. The grounding part of the ontology enables mapping of OWL-S inputs and outputs to the corresponding inputs and outputs in the WSDL description of the service. Hence, OWL-S can be used with SOAP-based (Simple Object Access Protocol-based) Web services, which can provide a WSDL description to create Semantic Web services. For more information on OWL and OWL-S, see Deborah L. McGuinness & Frank van Harmelen (eds.), OWL Web Ontology Language Overview, W3C RECOMMENDATION (Feb. 10, 2004); and Martin et al., OWL-S. Semantic Markup for Web Services, W3C MEMBER SUBMISSION (Nov. 22, 2004), the contents of both of which is incorporated herein in their entireties.

Among the areas of the Web Services (including Semantic Web Services) that has drawn some interest is in the generation of user interfaces (UIs) for providing such services. In this regard, a number of techniques have been developed for defining and generating UIs for Web Services. Some of the more notable approaches include Apple's Sherlock application framework, which permits defining Web Service UIs using either JavaScript or XQuery. Other techniques for defining and generating UIs include, for example, Epicentric's Web Service User Interface specification, Oasis' Web Service Remote Portlets specification, and IBM's Web Service Experience Language specification. While techniques such as those above attempt to provide a simple means of specifying user interfaces for preexisting Web service interfaces, none of these conventional techniques fully automates UI generation.

### SUMMARY OF THE INVENTION

In view of the foregoing background, exemplary embodiments of the present invention therefore provide an architecture for the creation and personalization of dynamic UIs from Web service descriptions. The architecture of exemplary embodiments of the present invention exploits the semantic relationships between type information of Web service input fields, and their association with information the system has regarding the user or recipient of the service, to personalize and simplify the invocation of Web services. Such user information may include, for example, the user's current context, personal information manager (PIM) data, context history, usage history, corporate data, etc.

According to one aspect of the present invention, a method of facilitating a service is provided. The method includes receiving a description of a service, and invoking the service based on the description. In this regard, the description comprises one having been generated based on an ontology including a set of classes, instances and associated properties for describing a user interface (UI) that includes one or more fields. The set of classes, instances and associated properties include a class for describing a field of the UI, and one or more properties for describing a name of the respective field and/or a UI widget for implementing the respective field. In this regard, the description includes a UI model of the service, where the UI model includes one or more of the classes, instances and associated properties of the ontology. Invoking the service, then, includes generating a UI based on the UI model.

The ontology may include a further set of classes, instances and associated properties for describing the service. As such, the description may further include a profile and process model that each include one or more classes, instances and associated properties of the further set of classes, instances and associated properties. The UI model may further include values associated with respective properties thereof. Thus, in instances further including a profile and process model, one or more of the values of the UI model may refer to one or more classes of the profile and/or process model.

In addition to generating a UI based on the description of the service, the UI may be generated further based on information associated with a user requesting the services such as personal information management (PIM) information, personal profile information, current context information and/or context history information. More particularly, the UI may be generated based on one or more relationships between the information associated with the user and one or more fields of the UI. For example, the UI may be generated by determining information related to one or more fields of the UI based on information associated with the user, where the UI model of the service including one or more properties describing one or more UI widgets for implementing one or more fields of the UI. The UI for the service can then be generated including generating one or more UI widgets for one or more fields for which (a) the UI model includes one or more properties describing a UI widget, and (b) information related to the respective one or more fields is determined. In such instances, the respective one or more UI widgets are generated based on the information related to the respective one or more fields. In another example, the UI may be generated by determining input data for one or more fields of the UI based on information associated with the user, and generating a UI without one or more UI widgets for one or more fields for which the UI model includes one or more properties describing a UI widget, and for which input data is determined.

According to other aspects of the present invention, a network entity (e.g., proxy), recipient, a method and computer program products for facilitating a service are provided. As indicated above and explained below, the proxy, recipient, methods and computer program products of exemplary embodiments of the present invention may solve the problems identified by prior techniques and/or provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as a terminal, computing system, data source, transformation proxy, semantic web service, web service proxy and/or reasoner, in accordance with exemplary embodiments of the present invention;

FIG. 3 is a graph for a UI model of AltaVista's Babel Fish translator Web service, in accordance with exemplary embodiments of the present invention;

FIG. 4 is a functional block diagram of a system for providing a Web service in accordance with one exemplary embodiment of the present invention;

FIG. 5 is a flowchart including various steps in a method of providing a Web service, in accordance with exemplary embodiments of the present invention; and

FIGS. 6-11 are exemplary UIs generated in accordance with exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

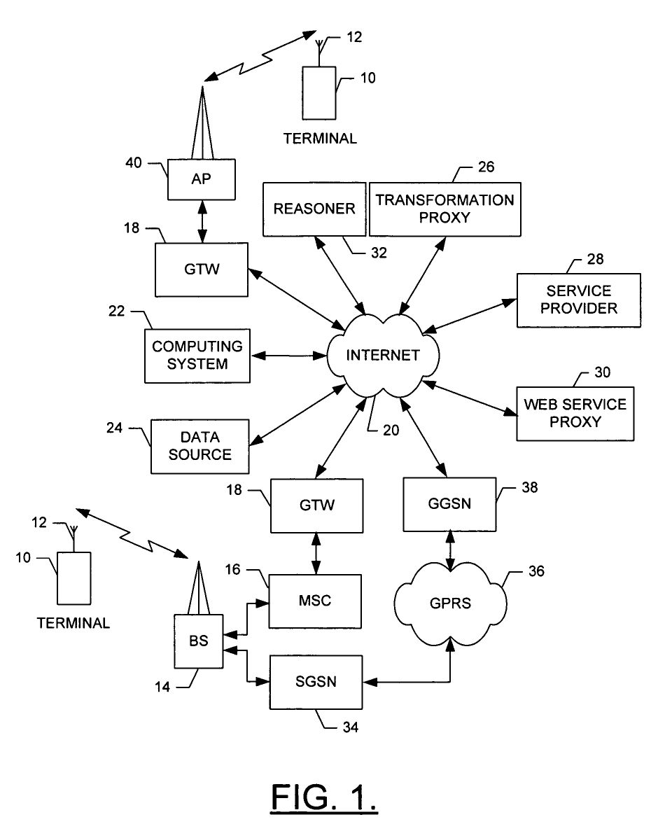

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, one or more terminals 10 may each include an antenna 12 for transmitting signals to and for receiving signals from a base site or base station (BS) 14. The base station is a part of one or more cellular or mobile networks each of which includes elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with a computing system 22, data source 24, transformation proxy 26, service provider 28 (e.g., semantic web service provider), web service proxy 30, reasoner 32 (one of each being shown in FIG. 1) or the like, as described below.

The BS 14 can also be coupled to a signaling GPRS (General Packet Radio Service) support node (SGSN) 34. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 36. The packet-switched core network is then coupled to another GTW, such as a GTW GPRS support node (GGSN) 38, and the GGSN is coupled to the Internet. In addition to the GGSN, the packet-switched core network can also be coupled to a GTW 18. Also, the GGSN can be coupled to a messaging center. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 34 to the GPRS core network 36 and the GGSN 38, devices such as a computing system 22, data source 24, transformation proxy 26, service provider 28, web service proxy 30 and/or reasoner 32 can be coupled to the terminal 10 via the Internet 20, SGSN and GGSN. In this regard, devices such as a computing system, data source, transformation proxy, service provider, web service proxy and/or reasoner can communicate with the terminal across the SGSN, GPRS and GGSN. By directly or indirectly connecting the terminals and the other devices (e.g., computing system, origin server, etc.) to the Internet, the terminals can communicate with the other devices and with one another to thereby carry out various functions of the terminal and/or one or more of the other devices.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 40. The APs can comprise access points configured to communicate with the terminal in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs may be coupled to the Internet 20. Like with the MSC 16, the APs can be directly coupled to the Internet. In one embodiment, however, the APs are indirectly coupled to the Internet via a GTW 18. As will be appreciated, by directly or indirectly connecting the terminals and the computing system 22, data source 24, transformation proxy 26, service provider 28, web service proxy 30, reasoner 32, and/or any of a number of other devices, to the Internet, the terminals can communicate with one another, the computing system, etc., to thereby carry out various functions of the terminal, such as to transmit data, content or the like to, and/or receive content, data or the like from, the computing system. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the terminal 10 to computing systems 22, data sources 24, transformation proxies 26, service provider s 28, web service proxies 30 and/or reasoners 32 across the Internet 20, the terminal and one or more computing systems, data sources, transformation proxies, service providers, web service proxies and/or reasoners can be coupled to one another and communicate in accordance with, for example, RF, BT, IrDA or any of a number of different wireline or wireless communication techniques, including LAN, WLAN, WiMAX and/or UWB. techniques. One or more of the computing systems can additionally, or alternatively, include a removable memory capable of storing content, which can thereafter be transferred to the terminal. Further, the terminal 10 can be coupled to one or more electronic devices, such as printers, digital projectors and/or other multimedia capturing, producing and/or storing devices (e.g., other terminals). Like with the computing systems, data sources, transformation proxies, service providers, web service proxies and/or reasoners, the terminal can be configured to communicate with the portable electronic devices in accordance with techniques such as, for example, RF, BT, IrDA or any of a number of different wireline or wireless communication techniques, including USB, LAN, WLAN, WiMAX and/or UWB techniques.

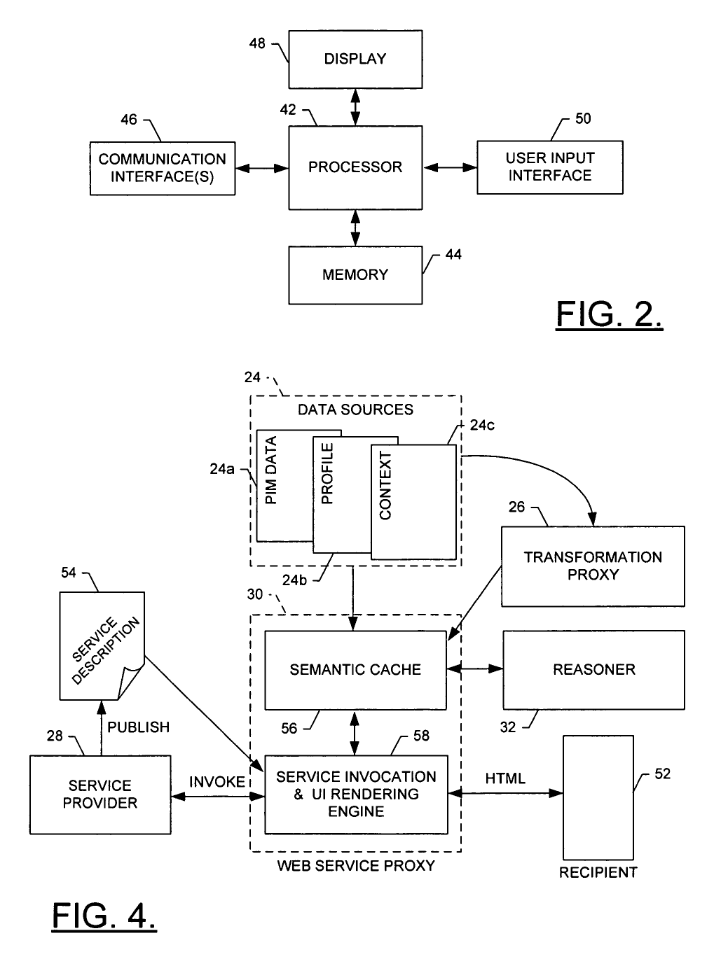

Referring now to FIG. 2, a block diagram of an entity capable of operating as a terminal 10, computing system 22, data source 24, transformation proxy 26, service provider 28, web service proxy 30 and/or reasoner 32, is shown in accordance with one embodiment of the present invention. Although shown as separate entities, in some embodiments, one or more entities may support one or more of a terminal, computing system, data source, transformation proxy, service provider, web service proxy, reasoner, logically separated but co-located within the entit(ies). For example, a single entity may support a logically separate, but co-located, data source and transformation proxy. Also, for example, a single entity may support a logically separate, but co-located service provider, web service proxy and/or data source. In addition, for example, a single entity may support a logically separate, but co-located terminal or computing system, and web service proxy. Further, for example, a single entity may support a logically separate, but co-located computing system, and transformation proxy, web service proxy and/or reasoner.

The entity capable of operating as a terminal 10, computing system 22, data source 24, transformation proxy 26, service provider 28, web service proxy 30 and/or reasoner 32 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 42 connected to a memory 44. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

As described herein, the client application(s) may each comprise software operated by the respective entities. It should be understood, however, that any one or more of the client applications described herein can alternatively comprise firmware or hardware, without departing from the spirit and scope of the present invention. Generally, then, the terminal 10, computing system 22, data source 24, transformation proxy 26, service provider 28, web service proxy 30 and/or reasoner 32 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., terminal, computing system, data source, transformation proxy, service provider, web service proxy, reasoner, etc.) or more particularly, for example, a processor 42 of the respective network entity. The design of integrated circuits is by and large a highly automated process. In this regard, complex and powerful software tools are available for converting a logic level design into a semiconductor circuit design ready to be etched and formed on a semiconductor substrate. These software tools automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 44, the processor 42 can also be connected to at least one interface or other means for displaying, transmitting and/or receiving data, content or the like. In this regard, the interface(s) can include at least one communication interface 46 or other means for transmitting and/or receiving data, content or the like. For example, the communication interface(s) can include a first communication interface for connecting to a first network, and a second communication interface for connecting to a second network. In addition to the communication interface(s), the interface(s) can also include at least one user interface that can include one or more earphones and/or speakers, a display 48, and/or a user input interface 50. The user input interface, in turn, can comprise any of a number of devices allowing the entity to receive data from a user, such as a microphone, a keypad, a touch display, a joystick, image capture device (e.g., digital camera) or other input device.

As explained in the background section, among the areas of the Web Services (including Semantic Web Services) that has drawn some interest is in the generation of user interfaces (UIs) for providing such services. And although techniques have been developed for defining and generating UIs for Web Services, such techniques fully automates UI generation. Exemplary embodiments of the present invention therefore provide an architecture for the creation and personalization of dynamic UIs from Web service descriptions. The architecture of exemplary embodiments of the present invention exploits the semantic relationships between type information of Web service input fields, and their association with information the system has regarding the user or recipient of the service, to personalize and simplify the invocation of Web services. Such user information may include, for example, the user's current context, personal information manager (PIM) data, context history, usage history, corporate data, etc.

Exemplary embodiments of the present invention will be described herein with reference to the OWL-S ontology, and as a consequence, a brief description of that ontology is provided below. It should be understood, however, that exemplary embodiments of the present invention may be equally applicable with reference to a number of other ontologies (e.g., Web Service Modeling Ontology—WSMO), without departing from the spirit and scope of the present invention.

The OWL-S ontology provides an upper ontology for services, including the properties normally associated with such services. In this regard, the OWL-S description for a service can be structured into a profile, process model and grounding, each of which may include a set of classes, properties and values, the classes, instances and properties being defined by the OWL ontology. Generally, the service profile answers the question of what the service provides in a manner sufficient for a service-seeking agent (or matchmaking agent acting on behalf of a service-seeking agent) to determine whether the service meets its needs. The service profile, for example, may include a description of what is accomplished by the service, limitations on service applicability and quality of service, and requirements that the service requester must satisfy to successfully use the service. The process model answers the question of how the service is used by detailing the semantic content of requests, the conditions under which particular outcomes will occur, and, where applicable, the step-by-step processes leading to those outcomes. The grounding answers the question of how one interacts with the service by specifying a communication protocol, message formats, and other service-specific details (e.g., port numbers) used in contacting the service. In addition, the grounding may include, for each semantic type of input or output specified in the process model, an unambiguous manner of exchanging data elements of that type with the service.

More particularly, the classes, instances and properties may include the class Service, which provides an organizational point of reference for a declared Web service. One instance of Service will exist for each distinct published service, with the properties presents, describedBy, and supports being properties of Service. In this regard, the profile of the service can be used to advertise the service, and can be captured by the class ServiceProfile, which may be presented by each instance of Service. The process model can be captured by the class ServiceModel, which may be describedBy each instance of Service. And finally, the grounding provides details regarding transport protocols with which the service may be implemented, and can be captured by the class ServiceGrounding, which may be supported by each instance of Service. Further declaring and describing a respective service, one or more of the classes ServiceProfile, ServiceModel and ServiceGrounding can provide one or more properties for which one or more respective subclasses and/or values may be specified.

The architecture of exemplary embodiments of the present invention may use the OWL-S profile and process model of a service as the basic representation from which to generate a form-based UI. In this regard, as explained above, the OWL-S ontology provides a rich vocabulary that can be used for describing not only the (call-) interface of a service, but also other aspects that may be helpful in generating a UI. In various instances, however, one or more aspects of a desired UI may not be “derivable” from OWL-S descriptions. Thus, exemplary embodiments of the present invention extend the ontology to include user interface annotations (classes, instances and properties). These extensions may provide cues regarding, for example, display labels used for fields, and/or preferred UI widget types. As used herein, a widget may refer to an element of a UI, such as a free-text input element, checkbox element, or the like, that displays information or provides a specific way for a user to interact with the service being provided. Also, for example, such extensions may provide cues regarding how to render fields with pre-determined ranges or values (e.g., a selection list) as well as the ordering of available values in such fields, grouping of fields and subfields, and/or how to generate the serialized RDF data from inputs specified by the user (the generation of serialized RDF may be required to invoke Semantic Web services).

More particularly, in addition to the classes, instances and properties that may otherwise be provided by an ontology such as OWL-S, the ontology of exemplary embodiments of the present invention can include the a number of classes, instances and properties dedicated to generation of one or more UIs associated with the service. In this regard, the ontology of exemplary embodiments of the present invention can further include classes, instances and properties for defining a UI model of a service. In this regard, the UI model of a service may be captured by the class UIModel, for providing details regarding one or more UIs for providing the service. Each UIModel may be supported by a particular service and have one or more associated process UIs, which may be captured by the class ProcessUI and linked to the UIModel by the property hasProcessUI.

Multiple UIs can be associated with a single process, and as such, each ProcessUI may be linked to a particular process (e.g., class ServiceModel). In addition, each ProcessUI can be linked to one or more field maps that provide cues pertaining to the input and output fields involved in the process interaction, and can be captured by one or more instances of the subclass UIFieldMap (linked by the property hasUIFieldMap). It should be noted, however, that a set of related fields can be grouped together by an instance of the subclass FieldMapList that, in turn, has individual UIFieldMap instances as members.

Each field map or instance of the subclass UIFieldMap can include or otherwise specify one or more properties, some examples of which will now be described. The subclass UIFieldMap can specify a parameterName property having a value that points or otherwise refers to a class specified in the OWL-S profile or process model. Since every input and output parameter in OWL-S has an associated parameter type, the semantic type associated with the field can be identified using the parameterName property. Another property, parameterTypePath, can specify a path that is used to create an OWL instance from the specified user inputs in the generated UI. The fieldType property provides cues about the type of UI widget used for the given field such as, for example, single select, multiple select, checkbox or the like. Alternatively, thefieldType property can specify the widget type at a higher level, such as select one or select many. In such instances, a widget can be chosen at runtime based on available data regarding the field. In another alternative, the fieldType property can specify the type FieldSet referring to multiple subfields. For example, a currency converter service can include price and currency as input fields. The input price can then further include amount and currency as subfields, which may be specified using the property hasSubfieldMap that has the subclass FieldMapList as range or value.

Other properties, instanceDataLocation, instanceSelectionPath and displayLabelPath, can be used for fields that have a predetermined range or value. In this regard, the instanceDataLocation property can specify a value comprising an address (e.g., uniform resource locator—URL) at which a predetermined range or value can be found. For example, a language translator service may specify possible values for input language and output language by pointing to an ontology regarding languages supported by the service. Multiple locations for loading instance data can be specified using this property. The instanceSelectionPath property can then specify the path query required to select instance data from the specified data locations. And the displayLabelPath property can specify a path for finding the label for the instance of a respective UI widget.

In addition to the above properties, the UI Model fields may specify information about how conservative the UI generation scheme must be. Using the UI Model, for example, strict ordering of input fields, and/or strict ordering for elements in predetermined selection style widgets, can be imposed.

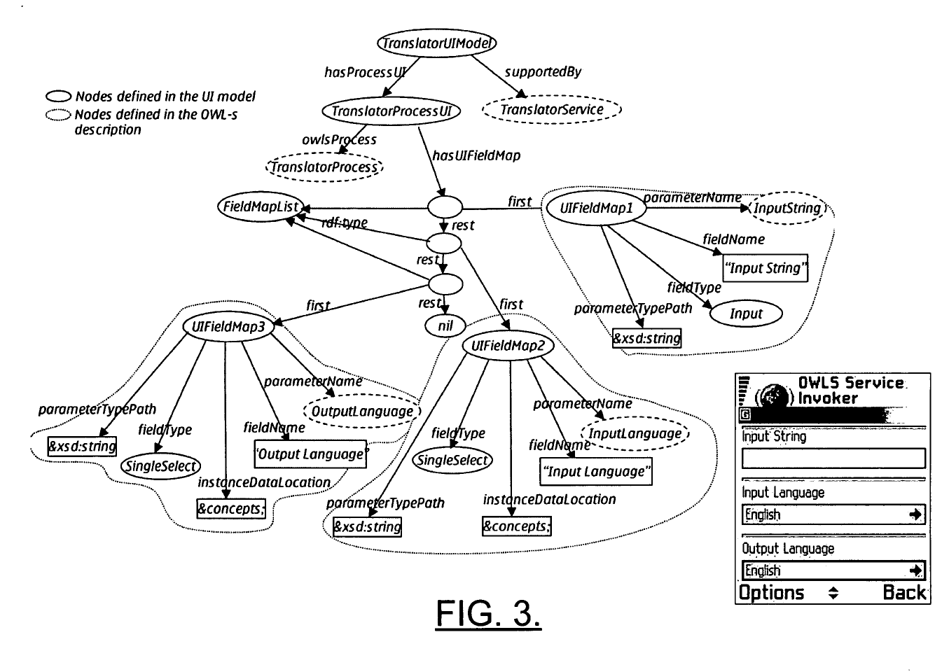

Reference is now briefly made to FIG. 3, which illustrates a graph for the UI model of AltaVista's Babel Fish translator Web service, as well as the corresponding dynamic user interface generated by a rendering engine (the oval nodes representing classes, subclasses or instances, the square nodes referring to values, and the arrowed line callouts referring to properties). As shown, the UI model can be supported by the service captured by TranslatorService, and has an associated process UI captured by TranslatorProcessUI. The specified process UI is linked to the process (e.g., class ServiceModel) TranslatorProcess and has several UI fields. Each UI field (UIFieldMap) is specified as a mapping between the associated parameter in the OWL-S description and other properties for rendering (and invoking) the UI. In this regard, FIG. 3 illustrates three UI field map nodes, one for each of the OWL-S input parameters, namely Input String, Input Language and Output Language.

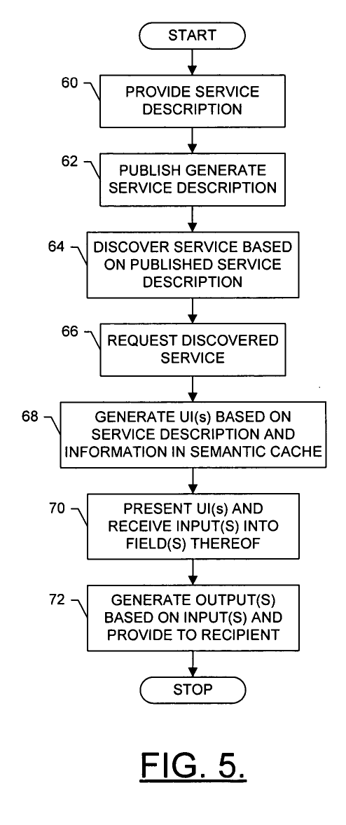

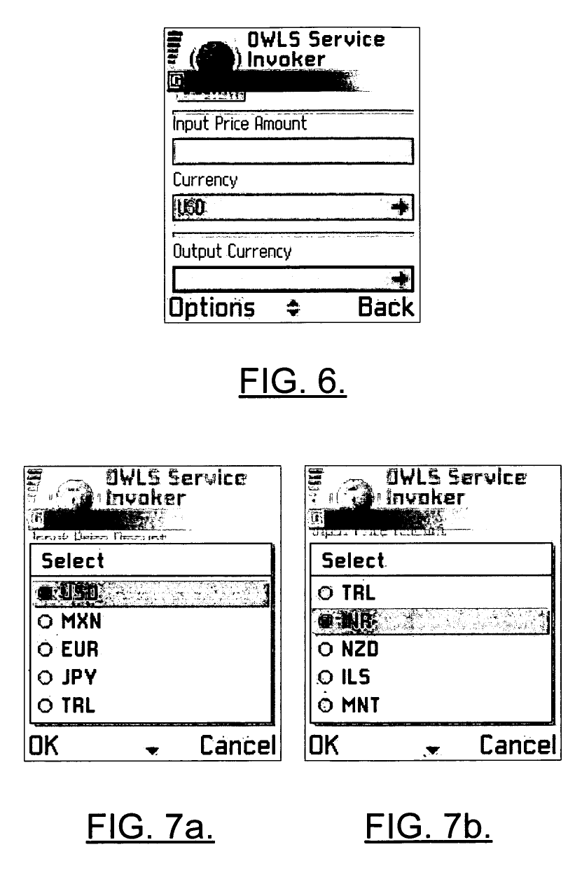

Having described the extended UI Model ontology of exemplary embodiments of the present invention, reference is now made to FIGS. 4 and 5, which illustrate a functional block diagram of a system of presenting Web services, and a flowchart including various steps in a method of presenting Web services, in accordance with exemplary embodiments of the present invention. The system includes a recipient 52 requesting, and thereafter receiving, a service of a service provider 28 (e.g., semantic web service provider), such as via a web service proxy 30. As shown, the recipient can comprise any of a number of network entities including, for example, a terminal 10, computing system 22 or the like. The service provider exposes its service by publishing a service description 54 created using the ontology of exemplary embodiments of the present invention, which may include a legacy ontology (e.g., OWL-S) and an extended UI Model ontology. In this regard, the UI Model for the service may be provided by the service provider, or alternatively by another network element such as a computing system 22. For example, the UI Model could be provided by an enterprise (via, e.g., a computing system) that may make services available to employees within an organization, and that by appropriately configuring the UI Model, may make decisions about the allowed level of personalization of the service.

As also shown, the web service proxy 30 can include a repository, referred to as a semantic cache 56, capable of receiving information from one or more data sources 24. As explained above, form-based UIs can be generated from service descriptions, and in various instances, from service descriptions augmented with UI cues. Further aspects of exemplary embodiments of the present invention further improve generation of UIs using additional information regarding the recipient 52, or more particularly the user of the recipient, requesting and receiving a Web service, such as the current context, history of actions or the like. This information can be stored in the semantic cache. The architecture of exemplary embodiments of the present invention can therefore exploit semantic relationships between type information of Web service input (and output) fields and their association with data in the semantic cache.

The semantic cache 56 can receive additional information from any of a number of data sources 24. For example, the semantic cache may receive additional information from PIM information (PIM data 24a), such as address book entries, calendar entries or the like, associated with the recipient 52. Additionally or alternatively, for example, the semantic cache may receive additional information from the recipient's (or user of the recipient's) personal profile 24b, and/or from the recipient's (or user's) current context and/or context history (context 24c). Further, for example, the semantic cache may receive additional information from a history of inputs/outputs in recently invoked services, and/or corporate or other institutional and/or organizational data, such as company phone book, organization hierarchies, or the like. These data sources may use one or more semantic models to represent their information or data objects, such as those that may be created using OWL. In a number of different instances, a subset of information stored by the data sources are cached at the semantic cache, which may reduce the response time for generating UIs in comparison to those instances making use of an extended amount of available additional information from a number of different data sources.

The semantic cache 56 may store one or more semantic models and data annotated with these models. The semantic cache may also implement an algorithm to constantly add information to and/or remove information from the cache based on the usage patterns of the data objects in the cache (the semantic cache referring not only to a cache for storing information, but also to software for managing that information). The algorithm may also add and/or remove information based on semantic relationships between information in the cache to thereby enable the addition and/or removal of a set of semantically similar objects all together. Further, algorithm may also add and/or remove information based on the nature of the data sources 24 involved, such as a transient nature of the user's current context, the static nature of the user's profile, and the like.

As also shown, the web service proxy 30 includes a service invocation and UI rendering engine 58 for invoking a service of the service provider 28, and generating one or more UIs for providing the service to the recipient 52. Thus, as shown in blocks 64 and 66, a method of providing a Web service may include a recipient discovering and requesting a service from a service provider, such as via a web service proxy. As shown in block 60, before the service provider receives the request, however, the service provider may generate or otherwise be provided with a service description 54 for the requested service based upon the ontology of exemplary embodiments of the present invention, as explained above. The service provider may then publish or otherwise expose the service description for use in discovering and invoking the service, as shown in block 62. Thus, upon the recipient discovering and requesting the service, the service invocation and UI rendering engine 58 can invoke the respective service with the service provider. The service can then be provided to the recipient, with the engine generating or otherwise rendering one or more dynamic web-based UIs (formatted, e.g., in accordance with Hypertext Markup Language (HTML), the Extensible HTML (XHTML), XForms, etc.) based on the service description, such as by loading or otherwise receiving an OWL-S description and UIModel and generating the UIs based thereon, as shown in block 68.

During invocation of the service, the service invocation and UI rendering engine 58 may generate the UIs further based on information in the semantic cache 56, such as by using explicit and/or implicit relationships between fields of the UIs and information in the semantic cache to personalize the UIs to the recipient, or more particularly the user of the recipient. In this regard, implicit relationships in the semantic cache may be inferred using a reasoner 32, such as a computing system operating one or more of the Cerebra® family of products available from Cerebra Inc. of Carlsbad, Calif., RacerPro software available from Racer Systems GmbH & Co. KG of Hamburg, Germany, or the like. At least some of the data sources 24, and by extension at least some of the information provided by those data sources, have associated type information including, for example, profile information, context history, PIM data, common sense information, and the like. Thus, the reasoner may be adapted to determine the relevance of data from a given data source based upon type information associated therewith. As further shown, the system may also include a transformation proxy 26 that enables the system to support data originating from legacy applications. In this regard, the transformation proxy enables on-the-fly generation of semantically-annotated data (e.g., data described using an OWL ontology) from legacy sources (e.g., calendar data from Outlook exposed as iCalendar or vCalendar entries, etc.).

More particularly as to personalizing UIs, while providing a Web service (e.g., Semantic Web service), the type information (e.g., parameterType property) associated with the input fields of the involved UI is used to retrieve information from the cache 56. In this regard, the retrieved information may be considered instances of the class specified as the type of the field. By making use of the reasoner 32, the engine 58 may query for both explicit and implicit information of a given type. The retrieved information may be weighted based on the nature of the data sources from which the information originated, as well as their frequency of occurrence. The semantic distance between pre-specified information used by fields of the service and information in the cache can also be used to determine the relevance of a given instance. In the case of composite Web services, the relevance of a semantic instance in the cache can further be inferred based on the atomic services that constitute the service, and be based on the control constructs (e.g., Sequence, Split, etc.) specified in the service's process model. The weights can be further adjusted based on the current context. The cumulative weight of given information, then, may facilitate determining the relevance of its use. The engine can then customize or otherwise personalize the UI(s) based on the retrieved information. For example, the engine can eliminate user input widgets for fields where the answer is already known with sufficient certainty, change UI widgets where the input values can be predetermined (e.g., change a free-text input widget to an editable selection list), provide intelligent default values for certain fields, and/or reorder and/or narrow down element lists in widgets such as selection lists, checkboxes, and the like.

Semantic Web techniques (e.g., ontologies, reasoning, rich semantic models, etc.) can also be used in determining the recipient's current usage context and manage definitions of contexts. In this regard, making the context definitions derived via semantic reasoning (via reasoner 32) available to the semantic cache 56, and consequently to engine 56 for use during the UI generation process, can improve the system's ability to discover implicit relationships between objects in the cache. The recipient's context can further be applied to limit the amount of data to be considered when generating a UI. For example, in case of location-based services, only data relevant to the recipient's current location may be considered (or at least given priority). Additionally, considering context in UI generation may improve the recipient's perception that the system is behaving in a context-aware manner.

After the UI(s) are dynamically generated, the service invocation and UI rendering engine 58 may present the UI(s) to the recipient 52, the UI(s) including one or more fields for receiving input, as shown in block 70. As also shown, the UI(s) may then receive input into its field(s). Thereafter, the inputs can be provided to the service provider 28, which can generate one or more outputs based on the input(s), and provide those output(s) to the recipient in another generated UI to thereby provide the service, as shown in block 72. Additionally, one or more of the inputs may be provided to the semantic cache 56 to change the information therein, if appropriate. More particularly, for example, once the UI is generated and inputs are received from the recipient, the engine can create an instance (e.g., OWL instance) for each of some, if not all, of the input parameters specified in the service description, such as by using a parameterTypePath property. The input for creating an instance may be received from a single widget or from multiple widgets. In this regard, the engine can use grouping knowledge about fields along with the parameterTypePath to create a single instance from multiple widgets. Then, once the instances are created, the grounding of the service (e.g., OWL-S grounding) may be used to generate one or more outputs based on the specified inputs. The outputs of the service may then be provided to the recipient.

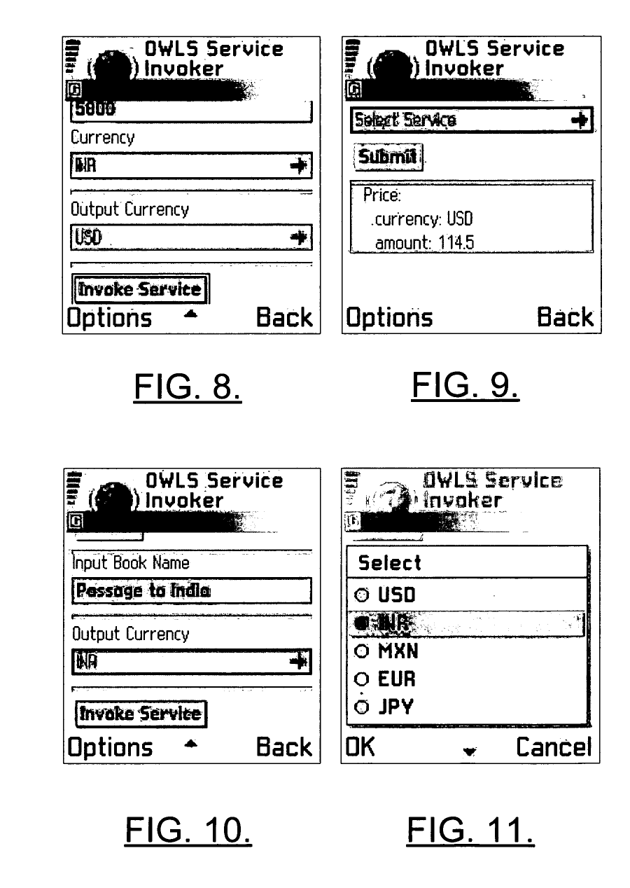

To further illustrate exemplary embodiments of the present invention, consider the following example. A user, and thus the user's mobile terminal 10 (recipient 52), visiting India is shopping for a souvenir to take back home. The user makes use of a currency converter service on the terminal to determine the price of the souvenir in a familiar currency. The currency converter takes three inputs: input price, input currency and output currency. The corresponding semantic types in an OWL-S description for each of these fields are: XMLSchema integer, Currency type (represented as an OWL Class URI) and Currency type, respectively. The corresponding widget types in the UIModel are: free-text input, single select drop-down list and multiple select drop-down list, respectively, as shown in FIG. 6.

Since the InputPrice field uses a free-text input widget and has type XML Schema, only values entered by the user to invoke the same service in the recent past are used from the semantic cache. Thus, if the service was accessed recently, then the respective field is displayed as an editable select list, with cached values, else a free-text input widget is presented. Also, since the InputCurrency and OutputCurrency fields have the type Currency and use drop-down list widgets (with pre-determined value ranges), the currencies are ordered in the list so that relevant currencies appear on the top of the list. If any instances of Currency are found in the cache 56 then they are likely to occur higher up on the list. Additionally, the ordering of currencies is determined by using the semantic relationship of the Currency type class with other classes in its ontology. From the currency ontology, the service invocation and UI rendering engine 58 determines that every Currency object is associated with one or more countries. Hence, the engine determines all relevant countries in the semantic cache to ascertain the ordering of currencies. In the rendered UI, US dollars (USD) appears high on the list because the user's profile indicates that he has an US residential address. The user's calendar information shows that the user recently attended a meeting in Helsinki, his context history indicates that he recently traveled via Tokyo and the use of GPS coordinates suggest that the user's current location is Bombay. By using simple geo-spatial reasoning, then, the cache determines that the user recently attended a meeting in Finland, that he recently traveled via Japan and that he is currently located in India; hence the currencies used in these countries (i.e., EUR, JPY and INR, respectively) appear high on the list. Similarly several other countries appear high on the list based on data in the semantic cache, as shown in FIGS. 7a and 7b. In the current context, the relevant inputs are INR as input currency and USD as output currency, as also shown in FIG. 8. Due to the reordering of currencies in the drop-down list, based on data in the semantic cache, the hassle of browsing through a long list (of 98 currencies) is avoided in this case. Once the service is invoked, the results are displayed to the user, as shown in FIG. 9.

Now presume that the user wants to buy a book from a local store, and check its price in local currency before the user gets to the store to pick it up. The user makes use of the store's book price finder service, which receives a book name and output currency as inputs. The corresponding types for these fields are: XMLSchema string and Currency. The corresponding widget types in the UIModel are: free-text input and multiple select drop-down list, respectively, as shown in FIG. 10. Since the INR object has semantic type Currency and was recently used as an input for service invocation, it appears higher on the list, making it easier to select, as shown in FIG. 11. Note that this service was never invoked in the past, yet personalization is done based on the semantic types of fields.

Personalization of the rendered UI can be accomplished further based on knowledge about the atomic services involved. For example, the book price finder service, presented earlier, may comprise a composite service based on three atomic services. It may first make use of a book details grabber service, which receives a book name as input and provides the ISBN number along with other details as output. It may then make use of a book price finder service, which receives the ISBN number and provides the price in USD as output. And finally, it may make use of a currency converter service to translate the price from USD to the desired currency. In the current exemplary scenario, knowledge about the currency converter atomic service helps in further deciding the weights given to individual currencies in the drop-down list.

As shown and described herein, a web service proxy 30 includes a semantic cache 56 and a service invocation and rendering engine 58. It should be understood, however, that one or both of the semantic cache and engine may alternatively be located in another network entity of the system, without departing from the spirit and scope of the present invention. Further, one or more data sources 24 may be located in another network entity of the system. For example, one or both the semantic cache and rendering engine of the web service proxy, and or one or more data sources, may be located at the recipient 52. In another example, only the rendering function of the engine may be located at the recipient, with the semantic cache and service invocation function of the rendering engine being located at the web service proxy (or another network entity). In such instances that both the semantic cache and rendering engine are located at another network entity, a web service proxy may be unnecessary.

According to one aspect of the present invention, the functions performed by one or more of the entities of the system, such as the terminal 10, computing system 22, data source 24, transformation proxy 26, service provider 28, web service proxy 30 and/or reasoner 32, may be performed by various means, such as hardware and/or firmware, including those described above, alone and/or under control of a computer program product. The computer program product for performing one or more functions of embodiments of the present invention includes a computer-readable storage medium, such as the non-volatile storage medium, and software including computer-readable program code portions, such as a series of computer instructions, embodied in the computer-readable storage medium.

In this regard, FIG. 5 is a flowchart of methods, systems and program products according to the invention. It will be understood that each block or step of the flowchart, and combinations of blocks in the flowchart, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart's block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A network entity for facilitating a service, the network entity comprising:
a processor for receiving a description of the service, the description having been generated based on an ontology including a set of classes, instances and associated properties for describing a user interface (UI) that includes one or more fields, the set of classes, instances and associated properties, the set including a class for describing a field of the UI, and one or more properties for describing one or more of a name of the respective field or a UI widget for implementing the respective field, wherein the processor is adapted to receive a description including a UI model of the service, the UI model including one or more of the classes, instances and associated properties of the ontology, and
wherein the processor is adapted to invoke the service based on the description, invoking the service including generating a UI based on the UI model.

2. A network entity according to claim 1, wherein the ontology includes a further set of classes, instances and associated properties for describing the service, wherein the processor is adapted to receive a description further including a profile and process model that each include one or more classes, instances and associated properties of the further set of classes, instances and associated properties, and
wherein the UI model further includes values associated with respective properties thereof, one or more of the values referring to one or more classes of one or more of the profile or process model.

3. A network entity according to claim 1, wherein the processor is adapted to generate a UI further based on information associated with a user requesting the service.

4. A network entity according to claim 3, wherein the processor is adapted to generate a UI based on information associated with the user including at least one of personal information management information, personal profile information, current context information, or context history information.

5. A network entity according to claim 3, wherein the processor is adapted to generate a UI based on one or more relationships between the information associated with the user and one or more fields of the UI.

6. A network entity according to claim 3, wherein the processor is adapted to generate a UI by:
determining information related to one or more fields of the UI based on information associated with the user, the UI model of the service including one or more properties describing one or more UI widgets for implementing one or more fields of the UI; and
generating a UI for the service including generating one or more UI widgets for one or more fields for which the UI model includes one or more properties describing a UI widget, and for which information related to the respective one or more fields is determined, the respective one or more UI widgets being generated based on the information related to the respective one or more fields.

7. A network entity according to claim 3, wherein the processor is adapted to generate a UI by:
determining input data for one or more fields of the UI based on information associated with the user, the UI model of the service including one or more properties describing one or more UI widgets for implementing one or more fields of the UI; and
generating a UI for the service without one or more UI widgets for one or more fields for which the UI model includes one or more properties describing a UI widget, and for which input data is determined.

8. A recipient for facilitating a service, the recipient comprising:
a processor for requesting a service that includes an associated description, the description having been generated based on an ontology including a set of classes, instances and associated properties for describing a user interface (UI) that includes one or more fields, the set of classes, instances and associated properties, the set including a class for describing a field of the UI, and one or more properties for describing one or more of a name of the respective field or a UI widget for implementing the respective field, wherein the processor is adapted to request a service that includes an associated description including a UI model of the service, the UI model including one or more of the classes, instances and associated properties of the ontology, and
wherein processor is adapted to receive the service based on the description, receiving the service including presenting a UI having been generated based on the UI model.

9. A recipient according to claim 8, wherein the ontology includes a further set of classes, instances and associated properties for describing the service, wherein the processor is adapted to request a service that includes an associated description further including a profile and process model that each include one or more classes, instances and associated properties of the further set of classes, instances and associated properties, and
wherein the UI model further includes values associated with respective properties thereof, one or more of the values referring to one or more classes of one or more of the profile or process model.

10. A recipient according to claim 8, wherein the processor is adapted to present a UI having been generated further based on information associated with a user requesting the service.

11. A recipient according to claim 10, wherein the processor is adapted to present a UI having been generated based on information associated with the user including at least one of personal information management information, personal profile information, current context information, or context history information.

12. A recipient according to claim 10, wherein the processor is adapted to present a UI having been generated based on one or more relationships between the information associated with the user and one or more fields of the UI.

13. A recipient according to claim 10, wherein the processor is adapted to present a UI having been generated by:
determining information related to one or more fields of the UI based on information associated with the user, the UI model of the service including one or more properties describing one or more UI widgets for implementing one or more fields of the UI; and
generating a UI for the service including generating one or more UI widgets for one or more fields for which the UI model includes one or more properties describing a UI widget, and for which information related to the respective one or more fields is determined, the respective one or more UI widgets being generated based on the information related to the respective one or more fields.

14. A recipient according to claim 10, wherein the processor is adapted to present a UI having been generated by:
determining input data for one or more fields of the UI based on information associated with the user, the UI model of the service including one or more properties describing one or more UI widgets for implementing one or more fields of the UI; and
generating a UI for the service without one or more UI widgets for one or more fields for which the UI model includes one or more properties describing a UI widget, and for which input data is determined.

15. A method of facilitating a service, the method comprising:
receiving a description of the service, the description having been generated based on an ontology including a set of classes, instances and associated properties for describing a user interface (UI) that includes one or more fields, the set of classes, instances and associated properties, the set including a class for describing a field of the UI, and one or more properties for describing one or more of a name of the respective field or a UI widget for implementing the respective field, wherein the receiving step comprises receiving a description including a UI model of the service, the UI model including one or more of the classes, instances and associated properties of the ontology; and
invoking the service based on the description, invoking the service including generating a UI based on the UI model.

16. A method according to claim 15, wherein the ontology includes a further set of classes, instances and associated properties for describing the service, wherein the receiving step comprises receiving a description further including a profile and process model that each include one or more classes, instances and associated properties of the further set of classes, instances and associated properties, and
wherein the UI model further includes values associated with respective properties thereof, one or more of the values referring to one or more classes of one or more of the profile or process model.

17. A method according to claim 15, wherein the generating step comprises generating a UI further based on information associated with a user requesting the service.

18. A method according to claim 17, wherein the generating step comprises generating a UI based on information associated with the user including at least one of personal information management information, personal profile information, current context information, or context history information.

19. A method according to claim 17, wherein the generating step comprises generating a UI based on one or more relationships between the information associated with the user and one or more fields of the UI.

20. A method according to claim 17, wherein the generating step comprises:
determining information related to one or more fields of the UI based on information associated with the user, the UI model of the service including one or more properties describing one or more UI widgets for implementing one or more fields of the UI; and
generating a UI for the service including generating one or more UI widgets for one or more fields for which the UI model includes one or more properties describing a UI widget, and for which information related to the respective one or more fields is determined, the respective one or more UI widgets being generated based on the information related to the respective one or more fields.

21. A method according to claim 17, wherein the generating step comprises:
determining input data for one or more fields of the UI based on information associated with the user, the UI model of the service including one or more properties describing one or more UI widgets for implementing one or more fields of the UI; and
generating a UI for the service without one or more UI widgets for one or more fields for which the UI model includes one or more properties describing a UI widget, and for which input data is determined.

22. A method of facilitating a service, the method comprising:
requesting a service that includes an associated description, the description having been generated based on an ontology including a set of classes, instances and associated properties for describing a user interface (UI) that includes one or more fields, the set of classes, instances and associated properties, the set including a class for describing a field of the UI, and one or more properties for describing one or more of a name of the respective field or a UI widget for implementing the respective field, wherein the requesting step comprises requesting a service that includes an associated description including a UI model of the service, the UI model including one or more of the classes, instances and associated properties of the ontology; and
receiving the service based on the description, receiving the service including presenting a UI having been generated based on the UI model.

23. A method according to claim 22, wherein the ontology includes a further set of classes, instances and associated properties for describing the service, wherein the requesting step comprises requesting a service that includes an associated description further including a profile and process model that each include one or more classes, instances and associated properties of the further set of classes, instances and associated properties, and
wherein the UI model further includes values associated with respective properties thereof, one or more of the values referring to one or more classes of one or more of the profile or process model.

24. A method according to claim 22, wherein the presenting step comprises presenting a UI having been generated further based on information associated with a user requesting the service.

25. A method according to claim 24, wherein the presenting step comprises presenting a UI having been generated based on information associated with the user including at least one of personal information management information, personal profile information, current context information, or context history information.

26. A method according to claim 24, wherein the presenting step comprises presenting a UI having been generated based on one or more relationships between the information associated with the user and one or more fields of the UI.

27. A method according to claim 24, wherein the presenting step comprises presenting a UI having been generated by:
determining information related to one or more fields of the UI based on information associated with the user, the UI model of the service including one or more properties describing one or more UI widgets for implementing one or more fields of the UI; and
generating a UI for the service including generating one or more UI widgets for one or more fields for which the UI model includes one or more properties describing a UI widget, and for which information related to the respective one or more fields is determined, the respective one or more UI widgets being generated based on the information related to the respective one or more fields.

28. A method according to claim 24, wherein the presenting step comprises presenting a UI having been generated by:
determining input data for one or more fields of the UI based on information associated with the user, the UI model of the service including one or more properties describing one or more UI widgets for implementing one or more fields of the UI; and
generating a UI for the service without one or more UI widgets for one or more fields for which the UI model includes one or more properties describing a UI widget, and for which input data is determined.

29. A computer program product for facilitating a service, wherein the computer program product comprises one or more computer-readable storage mediums having computer-readable program code portions stored therein, the computer-readable program code portions comprising:
a first executable portion for receiving a description of the service, the description having been generated based on an ontology including a set of classes, instances and associated properties for describing a user interface (UI) that includes one or more fields, the set of classes, instances and associated properties, the set including a class for describing a field of the UI, and one or more properties for describing one or more of a name of the respective field or a UI widget for implementing the respective field, wherein the first executable portion is adapted to receive a description including a UI model of the service, the UI model including one or more of the classes, instances and associated properties of the ontology; and
a second executable portion for invoking the service based on the description, invoking the service including generating a UI based on the UI model.

30. A method according to claim 29, wherein the ontology includes a further set of classes, instances and associated properties for describing the service, wherein the first executable portion is adapted to receive a description further including a profile and process model that each include one or more classes, instances and associated properties of the further set of classes, instances and associated properties, and
wherein the UI model further includes values associated with respective properties thereof, one or more of the values referring to one or more classes of one or more of the profile or process model.

31. A computer program product according to claim 29, wherein the second executable portion is adapted to generate a UI further based on information associated with a user requesting the service.

32. A computer program product according to claim 31, wherein the second executable portion is adapted to generate a UI based on information associated with the user including at least one of personal information management information, personal profile information, current context information, or context history information.

33. A computer program product according to claim 31, wherein the second executable portion is adapted to generate a UI based on one or more relationships between the information associated with the user and one or more fields of the UI.

34. A computer program product according to claim 31, wherein the second executable portion is adapted to generate a UI by:
determining information related to one or more fields of the UI based on information associated with the user, the UI model of the service including one or more properties describing one or more UI widgets for implementing one or more fields of the UI; and
generating a UI for the service including generating one or more UI widgets for one or more fields for which the UI model includes one or more properties describing a UI widget, and for which information related to the respective one or more fields is determined, the respective one or more UI widgets being generated based on the information related to the respective one or more fields.

35. A computer program product according to claim 31, wherein the second executable portion is adapted to generate a UI by:
determining input data for one or more fields of the UI based on information associated with the user, the UI model of the service including one or more properties describing one or more UI widgets for implementing one or more fields of the UI; and
generating a UI for the service without one or more UI widgets for one or more fields for which the UI model includes one or more properties describing a UI widget, and for which input data is determined.

36. A computer program product for facilitating a service, wherein the computer program product comprises one or more computer-readable storage mediums having computer-readable program code portions stored therein, the computer-readable program code portions comprising:
a first executable portion for requesting a service that includes an associated description, the description having been generated based on an ontology including a set of classes, instances and associated properties for describing a user interface (UI) that includes one or more fields, the set of classes, instances and associated properties, the set including a class for describing a field of the UI, and one or more properties for describing one or more of a name of the respective field or a UI widget for implementing the respective field, wherein the first executable portion is adapted to request a service that includes an associated description including a UI model of the service, the UI model including one or more of the classes, instances and associated properties of the ontology; and
a second executable portion for receiving the service based on the description, receiving the service including presenting a UI having been generated based on the UI model.

37. A computer program product according to claim 36, wherein the ontology includes a further set of classes, instances and associated properties for describing the service, wherein the first executable portion is adapted to request a service that includes an associated description further including a profile and process model that each include one or more classes, instances and associated properties of the further set of classes, instances and associated properties, and
wherein the UI model further includes values associated with respective properties thereof, one or more of the values referring to one or more classes of one or more of the profile or process model.

38. A computer program product according to claim 36, wherein the second executable portion is adapted to present a UI having been generated further based on information associated with a user requesting the service.

39. A computer program product according to claim 38, wherein the second executable portion is adapted to present a UI having been generated based on information associated with the user including at least one of personal information management information, personal profile information, current context information, or context history information.

40. A computer program product according to claim 38, wherein the second executable portion is adapted to present a UI having been generated based on one or more relationships between the information associated with the user and one or more fields of the UI.

41. A computer program product according to claim 38, wherein the second executable portion is adapted to present a UI having been generated by:
determining information related to one or more fields of the UI based on information associated with the user, the UI model of the service including one or more properties describing one or more UI widgets for implementing one or more fields of the UI; and
generating a UI for the service including generating one or more UI widgets for one or more fields for which the UI model includes one or more properties describing a UI widget, and for which information related to the respective one or more fields is determined, the respective one or more UI widgets being generated based on the information related to the respective one or more fields.

42. A computer program product according to claim 38, wherein the second executable portion is adapted to present a UI having been generated by:
determining input data for one or more fields of the UI based on information associated with the user, the UI model of the service including one or more properties describing one or more UI widgets for implementing one or more fields of the UI; and
generating a UI for the service without one or more UI widgets for one or more fields for which the UI model includes one or more properties describing a UI widget, and for which input data is determined.
